(19) United States
(12) Patent Application Publication
(10) Pub. No.: US 2022/0409455 A1
(43) Pub. Date: Dec. 29, 2022

(54) Water-Dispensing System for Use with a Wheelchair

(71) Applicant: THOMAS MULLENAUX, SAN PEDRO, CA (US)

(72) Inventor: THOMAS MULLENAUX, SAN PEDRO, CA (US)

(73) Assignee: AQUAPHANT, INC., LAS VEGAS, NV (US)

(21) Appl. No.: 17/521,991

(22) Filed: Nov. 9, 2021

Related U.S. Application Data
(63) Continuation-in-part of application No. 17/361,635, filed on Jun. 29, 2021.

(51) Int. Cl. A61G 5/10; B01D 53/26; C02F 1/28; E03B 3/28

(52) U.S. Cl. CPC A61G 5/10; B01D 53/265; C02F 1/283; E03B 3/28; C02F 2201/008; C02F 2201/005

(57) ABSTRACT

The water-dispensing system with wheelchair comprises a water generation system, a condensate pump, a condensate filter, a power circuit, a water storage reservoir, a housing, a flexible tubing, and a wheelchair. The wheelchair further comprises a backrest and a bench. The housing contains the water generation system, the condensate pump, the condensate filter, the power circuit, the water storage reservoir, and the flexible tubing. The water generation system, the condensate pump, the condensate filter, and the flexible tubing are fluidically connected. The housing mounts on the wheelchair. The water generation system and the condensate pump electrically connect to the power circuit. The water generation system and the condensate pump receive electric energy from the power circuit.

### CROSS REFERENCES TO RELATED APPLICATIONS

This non-provisional application claims priority under 35 USC 120 to U.S. non-provisional application Ser. No. 17/361,635 filed on Jun. 29, 2021 by the inventor: Thomas Mullenaux. This non-provisional application claims U.S. non-provisional application Ser. No. 17/361,635 in its entirety.

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of accessories for a wheelchair. (A61G5/10)

### SUMMARY OF INVENTION

The water-dispensing system with wheelchair comprises a water generation system, a condensate pump, a condensate filter, a power circuit, a water storage reservoir, a housing, a flexible tubing, and a wheelchair. The wheelchair further comprises a backrest and a bench. The housing contains the water generation system, the condensate pump, the condensate filter, the power circuit, the water storage reservoir, and the flexible tubing. The water generation system, the condensate pump, the condensate filter, and the flexible tubing are fluidically connected. The housing mounts on the wheelchair. The water generation system and the condensate pump electrically connect to the power circuit. The water generation system and the condensate pump receive electric energy from the power circuit.

These together with additional objects, features and advantages of the water-dispensing system with wheelchair will be readily apparent to those of ordinary skill in the art upon reading the following detailed description of the presently preferred, but nonetheless illustrative, embodiments when taken in conjunction with the accompanying drawings.

In this respect, before explaining the current embodiments of the water-dispensing system with wheelchair in detail, it is to be understood that the water-dispensing system with wheelchair is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the water-dispensing system with wheelchair.

It is therefore important that the claims be regarded as including such equivalent construction insofar as they do not depart from the spirit and scope of the water-dispensing system with wheelchair. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a perspective view of an embodiment of the disclosure.

FIG. 3 is a rear view of an embodiment of the disclosure.

FIG. 4 is an in-use view of an embodiment of the disclosure.

FIG. 5 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

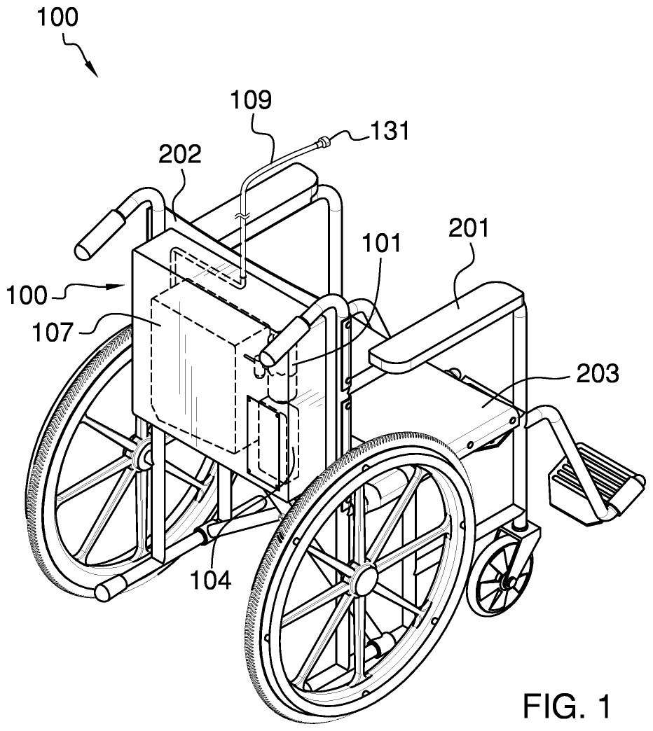

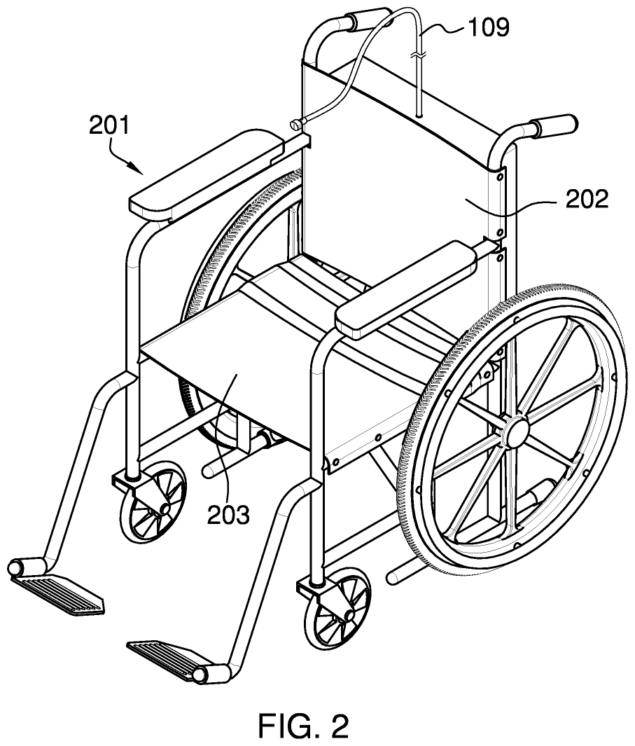

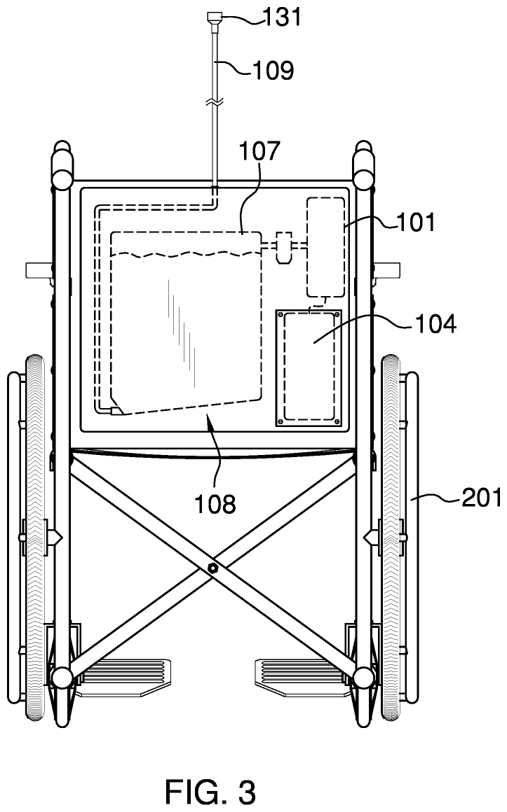

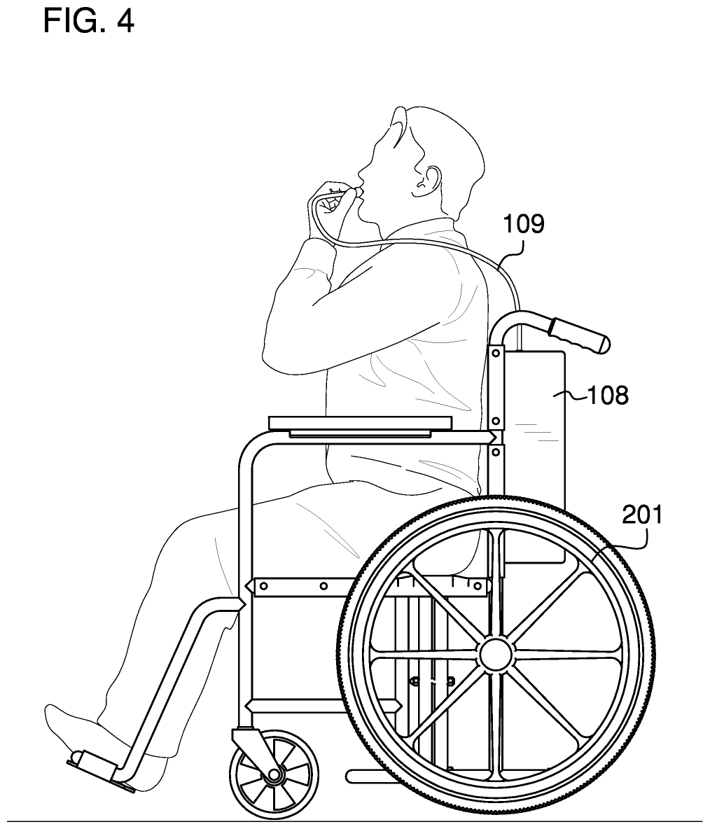

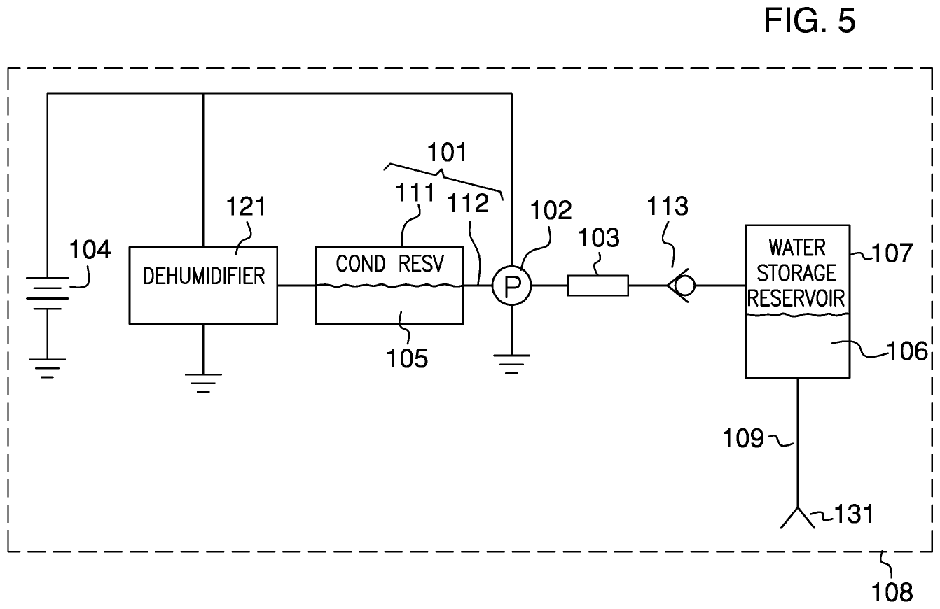

Detailed reference will now be made to one or more potential embodiments of the disclosure, which are illustrated in FIGS. 1 through 5.

The water-dispensing system with wheelchair 100 (hereinafter invention) comprises a water generation system 101, a condensate pump 102, a condensate filter 103, a power circuit 104, a water storage reservoir 107, a housing 108, a flexible tubing 109, and a wheelchair 201.

The water generation system 101, the condensate pump 102, the condensate filter 103, and the flexible tubing 109 are fluidically connected. The water generation system 101 and the condensate pump 102 electrically connect to the power circuit 104. The water generation system 101 and the condensate pump 102 receive electric energy from the power circuit 104. The housing 108 mounts on the wheelchair 201. The housing 108 is a rigid structure. The housing 108 contains the water generation system 101, the condensate pump 102, the condensate filter 103, the power circuit 104, the water storage reservoir 107, and the flexible tubing 109. The housing 108 is formed with all apertures and form factors necessary to allow the housing 108 to accommodate the use and operation of the invention 100.

The wheelchair 201 is a vehicle. The wheelchair 201 is a rolling structure used to transport a patient over a supporting surface. The wheelchair 201 is defined elsewhere in this disclosure. The housing 108 attaches to the wheelchair 201 such that the wheelchair 201 provides a constant source of drinking water 105 for the patient. The wheelchair 201 further comprises a backrest 202 and a bench 203. The bench 203 is a horizontally oriented surface on which the patient sits. The backrest 202 is a vertically oriented surface on which the patient leans. The backrest 202 and the bench 203 are defined elsewhere in this disclosure. The housing 208 mounts on the posterior surface of the backrest 202.

The water generation system 101 is a mechanical system that condenses water vapor from the atmosphere into a liquid phase condensate water 105. The condensate water 105 is a source of water generated by the water generation system 101. The water generation system 101 further comprises a dehumidifier 121 and a condensate reservoir 111. The dehumidifier 121 and the condensate reservoir 111 are fluidically connected.

The dehumidifier 121 is a device that changes the phase of water vapor in the atmosphere into the liquid phase condensate water 105. The dehumidifier 121 is an electrically operated device that draws electrical energy from the power circuit 104. The use of a dehumidifier 121 is well-known and documented in the mechanical arts.

The condensate reservoir 111 is a containment structure. The condensate reservoir 111 collects condensate water 105 from the dehumidifier 121. The condensate reservoir 111 stores the condensate water 105 until the condensate pump 102 pumps the condensate water 105 through the condensate filter 103 and into the water storage reservoir 107.

The condensate reservoir 111 further comprises a condensate discharge port 112. The condensate discharge port 112 is a fluidic connection formed between the condensate reservoir 111 and the condensate pump 102. The condensate pump 102 draws the condensate water 105 out of the condensate reservoir 111 through the condensate discharge port 112 for transport into the fluid input of the condensate filter 103.

The condensate pump 102 is a mechanical device. The condensate pump 102 is an electrically powered device. The condensate pump 102 generates a pressure differential. The pressure differential generated by the condensate pump 102 transports the condensate water 105 from the condensate reservoir 111 and through the condensate filter 103 into the water storage reservoir 107. The condensate reservoir 111 controls the operation of the condensate pump 102 by controlling the operation of an electric motor that drives the condensate pump 102. The use of a pump is well-known and documented in the mechanical arts.

The condensate filter 103 is a filtering device. The condensate filter 103 filters the condensate water 105 as it passes through the condensate filter 103. The condensate filter 103 converts the condensate water 105 into the drinking water 106 by removing impurities contained within the condensate filter 103. In the first potential embodiment of the disclosure, the condensate filter 103 is a bed filter that passes the condensate water 105 through a bed formed of activated carbon.

The condensate filter 103 further comprises a condensate check valve 113. The condensate check valve 113 forms a direct fluidic connection between the discharge port of the condensate filter 103 and the water storage reservoir 107. The condensate check valve 113 transports the drinking water 106 from the condensate filter 103 into the water storage reservoir 107. The condensate check valve 113 limits the direction of the flow of the drinking water 106 to the direction from the condensate filter 103 into the water storage reservoir 107.

The power circuit 104 is an electric circuit. The power circuit 104 provides the electric energy necessary to operate both the water generation system 101 and the condensate pump 102. The flexible tubing 109 transports drinking water 106 from the water storage reservoir 107 to the patient. In the first potential embodiment of the disclosure, the power circuit 104 is a battery.

The water storage reservoir 107 is a container that stores the drinking water 106 for the patient. The water storage reservoir 107 forms a fluidic connection with the condensate filter 103. The water storage reservoir 107 receives drinking water 106 from the condensate filter 103.

The flexible tubing 109 is a hose. The flexible tubing 109 transports the drinking water 105 from the water storage reservoir 107 to the patient. The patient draws the drinking water 105 through the flexible tubing 109 by sucking on the flexible tubing 109 to generate a partial vacuum. The partial vacuum generated by the patient draws the drinking water 105 out of the water storage reservoir 107 and through the flexible tubing 109 to the patient. The open end of the flexible tubing 109 that is distal from the water storage reservoir 107 further comprises a mouthpiece 131. The mouthpiece assists the patient in drinking the drink water 105 that is provided through the flexible tubing 109.

The following definitions were used in this disclosure:

Anterior: As used in this disclosure, anterior is a term that is used to refer to the front side or direction of a structure. When comparing two objects, the anterior object is the object that is closer to the front of the structure.

Appliance: As used in this disclosure, an appliance is a device or instrument intended to perform a single task.

Backrest: As used in this disclosure, a backrest is a vertical or vertically canted supporting surface formed along the posterior side of a chair. The backrest supports the back of a person sitting in the chair.

Ball: As used in this disclosure, a ball refers to an object with a spherical or nearly spherical shape.

Ball Check Valve: As used in this disclosure, a ball check valve is a type of check valve. A ball check valve is a valve that has a ball inserted into it such that the ball move freely within the valve structure. The flow of fluid applies a force to the ball check valve that provides the motive forces that move the ball within the valve structure. The ball check valve is structured such that the flow of a fluid through the ball check valve in a first direction presses the ball into the flow path of the fluid through the ball check valve such that the fluid will apply a pressure against the ball that closes the fluid flow path through the ball check valve in the first direction. The ball check valve is further structured such that the flow of a fluid through the ball check valve in a second direction pushes the ball out of the flow path of the ball check valve such that the ball check valve allows the flow of fluid in the second direction. The second direction is the opposite direction to the first direction.

Battery: As used in this disclosure, a battery is a chemical device consisting of one or more cells, in which chemical energy is converted into electricity and used as a source of power. Batteries are commonly defined with a positive terminal and a negative terminal.

Bench: As used in this disclosure, a bench is a horizontal supporting surface formed by a chair.

Chair: As used in this disclosure, a chair is a structure that a person can sit on. The horizontal resting surface a person sits on is called the bench. Seat is a common synonym for a chair.

Check Valve: As used in this disclosure, a check valve is a valve that permits the flow of fluid in a single direction. Within selected potential embodiments of this disclosure, the check valve is a commercially available product that is selected from the group consisting of a ball check valve, a Tesla valve, and a duck valve.

Distal: As used in this disclosure, distal refers to a directional sense or location of an object. Specifically, distal refers to a first object, or a side of a first object, that is distal from the medial axis, or more proximal to the side of the object, relative to a second object, or side of a second object.

Drinking Water: As used in this disclosure, drinking water is water that is deemed safe for drinking or use in cooking by humans. A synonym is potable water.

Duck Valve: As used in this disclosure, a duck valve is a check valve. The duck valve is formed from two or more elastomeric structures. When the two or more elastomeric structures are in their relaxed shape, the duck valve forms a seal. The seal is oriented such that a fluidic pressure differential in a first direction will separate the two or more elastomeric structures allowing the fluid to flow through the duck valve in the first directions. When the fluidic pressure differential is in a second direction that is opposite to the first direction, the fluidic pressure applies a pressure that maintains the two or more elastomeric structures in their relaxed shape and prevents the flow of fluid through the duck valve in the second direction. A duck valve derives its name from a commonly used shape of the two or more elastomeric structures. A duck valve is also called a silicone valve.

Exterior: As used in this disclosure, the exterior is used as a relational term that implies that an object is not contained within the boundary of a structure or a space.

External Power Source: As used in this disclosure, an external power source is a source of the energy that is externally provided to enable the operation of the present disclosure. Examples of external power sources include, but are not limited to, electrical power sources and compressed air sources.

Flow: As used in this disclosure, a flow refers to the passage of a fluid past a fixed point. This definition considers bulk solid materials as capable of flow.

Fluid: As used in this disclosure, a fluid refers to a state of matter wherein the matter is capable of flow and takes the shape of a container it is placed within. The term fluid commonly refers to a liquid or a gas.

Fluidic Connection: As used in this disclosure, a fluidic connection refers to a tubular structure that transports a fluid from a first object to a second object. Methods to design and use a fluidic connections are well-known and documented in the mechanical, chemical, and plumbing arts.

Force of Gravity: As used in this disclosure, the force of gravity refers to a vector that indicates the direction of the pull of gravity on an object at or near the surface of the earth.

Form Factor: As used in this disclosure, the term form factor refers to the size and shape of an object.

Gas: As used in this disclosure, a gas refers to a state (phase) of matter that is fluid and that fills the volume of the structure that contains it. Stated differently, the volume of a gas always equals the volume of its container.

Horizontal: As used in this disclosure, horizontal is a directional term that refers to a direction that is either: 1) parallel to the horizon; 2) perpendicular to the local force of gravity, or, 3) parallel to a supporting surface. In cases where the appropriate definition or definitions are not obvious, the second option should be used in interpreting the specification. Unless specifically noted in this disclosure, the horizontal direction is always perpendicular to the vertical direction.

Hose: As used in this disclosure, a hose is a flexible hollow prism-shaped device that is used for transporting liquids and gases. When referring to a hose in this disclosure, the terms inner dimension and outer dimension are used as they would be used by those skilled in the plumbing arts.

Housing: As used in this disclosure, a housing is a rigid structure that encloses and protects one or more devices.

Humidity: As used in this disclosure, humidity refers water vapor that is dissolved in the atmosphere. The mass of water dissolved into the atmosphere is limited by the temperature of the atmosphere.

Inferior: As used in this disclosure, the term inferior refers to a directional reference that is parallel to and in the same direction as the force of gravity when an object is positioned or used normally.

Lateral: As used in this disclosure, the term lateral refers to an axis of an object that is perpendicular in the transverse (posterior to anterior) direction and the sagittal (superior to inferior) direction. The distal surfaces of an object that intersect the lateral axis are often informally referred to as the “sides” of the object. The lateral axis is usually perpendicular to the primary sense of direction of the object. A lateral face refers to the surfaces of a prism structure that run between the congruent ends of the prism. Movement in a lateral direction is often called “sideways” movement.

Left and Right: As used in this disclosure, the terms left and right are directional references associated with an object. The object is further defined with an anterior surface and a posterior surface. The terms left and right are standardized naming conventions for the lateral directions of the object. The terms left and right use the human body for the initial definition of the orientation. Specifically, when a human body is viewed from posterior side towards the anterior side, the left side of the human body is the lateral side of the human body that contains the heart. The right side of the human body is the lateral side of the body that contains the bulk of the liver. The left and right sides of the human body remain unchanged by changes to the direction from which the human body is viewed. The left side of any object is the same side as the left side of the human body when the object is viewed is viewed from posterior side towards the anterior side. The right side of any object is the same side as the right side of the human body when the object is viewed is viewed from posterior side towards the anterior side. The left and right sides of the object remain unchanged by changes to the direction from which the object is viewed.

Liquid: As used in this disclosure, a liquid refers to a state (phase) of matter that is fluid and that maintains, for a given pressure, a fixed volume that is independent of the volume of the container.

Patient: As used in this disclosure, a patient is a person who is designated to receive a medical treatment, therapy or service. The term patient may be extended to an animal when used within the context of the animal receiving veterinary treatment or services.

Phase: As used in this disclosure, phase refers to the state of the form of matter. The common states of matter are solid, liquid, gas, and plasma.

Phase Change Terminology: As used in this disclosure, the following terms are used to describe a phase change. A phase change from a solid phase to a liquid phase is called melting. A phase change from a liquid phase to a solid phase is called freezing or solidification. A phase change from a solid phase to a gas phase is called sublimation. A phase change from a gas phase to a solid phase is called deposition. A phase change from a liquid phase to a gas phase is called evaporation. A phase change from a gas phase to a liquid phase is called condensation. A phase change from a gas phase to a plasma phase is called ionization. A phase change from a plasma phase to a gas phase is called recombination.

Port: As used in this disclosure, a port is an opening formed in a first object that allows a second object to pass through a boundary formed by the first object.

Posterior: As used in this disclosure, posterior is a term that is used to refer to the side of an object that is distal or in the opposite direction of the anterior side. When comparing two items, the posterior item is the item that is distal from the anterior of the object.

Primary Sense of Direction: As used in this disclosure, the primary sense of direction of an object refers to a vector that: 1) passes through the center of the object; and, 2) is parallel to the direction of travel when the anterior surface(s) of the object are leading the object into the direction of travel. This definition intends to align with what people would normally call the forward direction of an object.

Reservoir: As used in this disclosure, a reservoir refers to a container or containment system that is configured to store a liquid.

Solid: As used in this disclosure, a solid refers to a state (phase) of matter that: 1) has a fixed volume; and, 2) does not flow.

Superior: As used in this disclosure, the term superior refers to a directional reference that is parallel to and in the opposite direction of the force of gravity when an object is positioned or used normally.

Tank: As used in this disclosure, a tank is an enclosed hollow structure used to store a fluid.

Tesla Valve: As used in this disclosure, a Tesla valve is a type of check valve that requires the use of no moving parts.

Tube: As used in this disclosure, the term tube is used to describe a hollow prism-shaped device with two congruent open ends. While tubes that are suitable for use in this disclosure are often used to transport or conveys fluids or gases, the purpose of the tubes in this disclosure are structural. In this disclosure, the terms inner dimension and outer dimension of a tube are used as they would be used by those skilled in the plumbing arts.

Valve: As used in this disclosure, a valve is a device that is used to control the flow of a fluid (gas or liquid) through a pipe, tube, or hose.

Vertical: As used in this disclosure, vertical refers to a direction that is either: 1) perpendicular to the horizontal direction; 2) parallel to the local force of gravity; or, 3) when referring to an individual object the direction from the designated top of the individual object to the designated bottom of the individual object. In cases where the appropriate definition or definitions are not obvious, the second option should be used in interpreting the specification. Unless specifically noted in this disclosure, the vertical direction is always perpendicular to the horizontal direction.

Wheelchair: As used in this disclosure, a wheelchair is a vehicle. The wheelchair is a chair fitted with four or more wheels that is used for transporting a patient. The wheelchair is commonly used for young, sick or disabled persons. Within this disclosure, the common definition of wheelchair is extended to include a stroller.

With respect to the above description, it is to be realized that the optimum dimensional relationship for the various components of the invention described above and in FIGS. 1 through 5 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A water-dispensing system with wheelchair comprising
a water generation system, a condensate pump, a condensate filter, a power circuit, a water storage reservoir, a housing, a flexible tubing, and a wheelchair;
wherein the housing contains the water generation system, the condensate pump, the condensate filter, the power circuit, the water storage reservoir, and the flexible tubing;
wherein the housing mounts on the wheelchair;

2. The water-dispensing system with wheelchair according to claim 1
wherein the water generation system, the condensate pump, the condensate filter, and the flexible tubing are fluidically connected;
wherein the water generation system and the condensate pump electrically connect to the power circuit;
wherein the water generation system and the condensate pump receive electric energy from the power circuit.

3. The water-dispensing system with wheelchair according to claim 2
wherein the wheelchair is a vehicle;
wherein the wheelchair is a rolling structure used to transport a patient over a supporting surface;
wherein the housing attaches to the wheelchair such that the wheelchair provides a constant source of drinking water for the patient.

4. The water-dispensing system with wheelchair according to claim 3 wherein the water generation system is a mechanical system that condenses water vapor from the atmosphere into a liquid phase condensate water.

5. The water-dispensing system with wheelchair according to claim 4
wherein the water generation system further comprises a dehumidifier and a condensate reservoir;
wherein the dehumidifier and the condensate reservoir are fluidically connected.

6. The water-dispensing system with wheelchair according to claim 5
wherein the dehumidifier is a device that changes the phase of water vapor in the atmosphere into the liquid phase condensate water;
wherein the dehumidifier is an electrically operated device that draws electrical energy from the power circuit.

7. The water-dispensing system with wheelchair according to claim 6
wherein the condensate reservoir is a containment structure;
wherein the condensate reservoir collects condensate water from the dehumidifier;
wherein the condensate reservoir stores the condensate water;
wherein the condensate reservoir further comprises a condensate discharge port;
wherein the condensate discharge port is a fluidic connection formed between the condensate reservoir and the condensate pump.

8. The water-dispensing system with wheelchair according to claim 7
wherein the condensate pump draws the condensate water out of the condensate reservoir through the condensate discharge port for transport into the fluid input of the condensate filter;
wherein the condensate pump is a mechanical device;
wherein the condensate pump is an electrically powered device;
wherein the condensate pump transports the condensate water from the condensate reservoir and through the condensate filter into the water storage reservoir.

9. The water-dispensing system with wheelchair according to claim 8
wherein the condensate filter is a filtering device;
wherein the condensate filter filters the condensate water as it passes through the condensate filter;
wherein the condensate filter converts the condensate water into the drinking water by removing impurities contained within the condensate filter.

10. The water-dispensing system with wheelchair according to claim 9
wherein the condensate filter further comprises a condensate check valve;
wherein the condensate check valve forms a direct fluidic connection between the discharge port of the condensate filter and the water storage reservoir;
wherein the condensate check valve transports the drinking water from the condensate filter into the water storage reservoir;
wherein the condensate check valve limits the direction of the flow of the drinking water to the direction from the condensate filter into the water storage reservoir.

11. The water-dispensing system with wheelchair according to claim 10
wherein the power circuit is an electric circuit;
wherein the power circuit provides the electric energy necessary to operate both the water generation system and the condensate pump;
wherein the power circuit is a battery.

12. The water-dispensing system with wheelchair according to claim 11
wherein the water storage reservoir is a container that stores the drinking water for the patient;
wherein the water storage reservoir forms a fluidic connection with the condensate filter;
wherein the water storage reservoir receives drinking water from the condensate filter.

13. The water-dispensing system with wheelchair according to claim 12
wherein the flexible tubing is a hose;
wherein the flexible tubing transports the drinking water from the water storage reservoir to the patient;
wherein the open end of the flexible tubing that is distal from the water storage reservoir further comprises a mouthpiece.

14. The water-dispensing system with wheelchair according to claim 13
wherein the wheelchair further comprises a backrest and a bench;
wherein the bench is a horizontally oriented surface on which the patient sits;
wherein the backrest is a vertically oriented surface on which the patient leans;
wherein the backrest and the bench are defined elsewhere in this disclosure;
wherein the housing mounts on the posterior surface of the backrest.
